(19) United States
(12) Patent Application Publication
(10) Pub. No.: US 2017/0341091 A1
(43) Pub. Date: Nov. 30, 2017

(54) Self-Draining Shower Head

(71) Applicant: Varun Neil Wadhwa, Darien, CT (US)

(72) Inventor: Varun Neil Wadhwa, Darien, CT (US)

(21) Appl. No.: 15/168,092

(22) Filed: May 30, 2016

(51) Int. Cl. B05B 1/18; B05B 1/30

(52) U.S. Cl. CPC B05B 1/18; B05B 1/3026

(57) ABSTRACT

This invention completely mitigates the problem of water dripping out of a conventional shower head over a long period of time, and/or suddenly discharging from the shower head, long after the shutoff valve is closed. The invention is very simple and consists of drilling a small hole in the body of the shower head, and providing a flapper with a hinge on one side of the snall hole and a stopper on the other side. After the shutoff valve is closed, gravity and partial vacuum inside the shower head opens the hole, thereby destroying the partial vacuum and ensuring that residual water in the body of the shower head gets discharged immediately. When the shutoff valve is opened, water under high pressure ensures the flapper firmly closes the small hole, thereby preventing water from escaping through it.

### BACKGROUND

A conventional shower head comprises of a body connected to both an inflow member and an outflow member. The body is provided with a water inlet and a shutoff valve to control the flow of water. The outflow member consists of a plate with several perforations to ensure a large number of water jets. The body acts as a recipient and reservoir of water and is usually circular in shape. The drawback of the conventional shower head is that, after the shutoff valve is closed, water continues to drip out over time until the residual water gets fully discharged, resulting in an irritating dripping sound that can last for long periods of time. Water may also discharge suddenly after some time due to changes in pressure, thereby causing disturbance. This invention solves these problems by ensuring that residual water in the shower head drains out immediately and completely once the shutoff valve is closed.

### SUMMARY

This invention completely mitigates the problem of water dripping out of a shower head over a period of time, and/or suddenly discharging from the shower head long after the shutoff valve is closed. The invention provides a simple, effective means to do this for both new and existing shower heads of any size or shape, at low cost. The object of the invention is that residual water remaining in the body of the shower head be discharged immediately after the shutoff valve is closed. Another object of the invention is to reduce clogging and rusting of the large number of perforations in the outflow member due to water retention inside a conventional shower head.

### BRIEF DESCRIPTION OF THE DRAWING

FIG. 1 is a cross-sectional view of the modified shower head, and is not to scale.

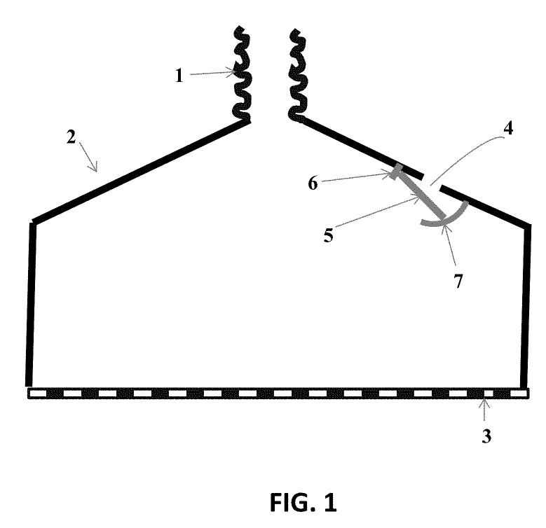

### DETAILED DESCRIPTION

In a conventional shower head, the inflow member 1 is usually a half-inch supply pipe with the ability to deliver water under pressure, controlled by a shutoff valve. The supply pipe is connected to a large-diameter body 2, usually 4- to 9-inches in diameter. After using the shower, when the supply of water is shut off from the shutoff valve, the pressure in the body 2 of the shower head eases and some, but not all, of the water in the body 2 discharges itself through the perforations in the outflow member 3. Partial discharge of water from the body 2 creates a partial vacuum in the body 2 above the remaining water, which then prevents the remaining water from discharging itself from the body 2. This is the root cause of the problem explained above. This invention seeks to quickly destroy the partial vacuum created above the water level in the body 2, resulting in a quick discharge of residual water in the body 2, thereby mitigating the problem of water dripping or discharging over long periods of time.

The invention comprises of a simple, effective modification to the conventional shower head. The modification consists of providing a small hole 4 (2- to 4-mm in diameter), with a flapper 5 and a hinge 6 on one side of the small hole 4, and a stopper 7 on the other side of the small hole 4, inside the body 2 of the shower head. The flapper 5 covers and uncovers the small hole 4, and the hinge 6 allows the flapper 5 to rotate over a limited angle, with the stopper 7 restricting the angular movement of the flapper 5. A 10- to 20-degree movement of the flapper 5 should normally be enough.

When the shutoff valve is opened in order to use the modified shower head, water under high pressure enters the body 2 of the shower head resulting in the flapper 5 firmly closing the small hole 4. This prevents water under high pressure from escaping the body 2 of the shower head through the small hole 4. After using the modified shower head, when the shutoff valve is closed, gravity along with partial vacuum in the body 2 of the shower head above the residual water line forces the flapper 5 to open the small hole 4. This results in the destruction of the partial vacuum above the residual water line, thereby forcing all of the residual water to quickly exit the body 2 of the shower head through perforations in the outflow member 3. Thus, no residual water remains in the body 2 after the shutoff valve is closed, thereby mitigating the problem of water dripping out of the shower head over time. The objective of the self-draining operation is therefore achieved in a simple and cost-effective manner.

No maintenance is required on the self-draining shower head; rather the invention ensures that perforations in the outflow member 3 remain clog free and do not rust over time. The invention is suitable for shower heads made of all types of materials such as stainless steel/chromium plated brass/bronze, and all kinds of plastics.

A diagram showing general features of the self-draining shower head is enclosed. It is to be understood, however, that variations in the drawing enclosed and description may be adopted within the scope of the invention.

1. The invention claims to quickly destroy the partial vacuum created above the water level in the shower head immediately after the shutoff valve is closed, resulting in quick discharge of residual water inside the body of the shower head.

2. A small hole provided in the body of the shower head to admit air from the atmosphere to the zone of partial vacuum above the surface of residual water.

3. A small flapper on a hinge and a stopper inside the body of the shower head to allow the flapper to rotate and cover and uncover the small hole.

4. The stopper of claim 3 to restrict the rotation of the flapper through a small angle about the hinge.

5. The flapper of claim 3 to cover the small hole in the body of the shower head when the shutoff valve is opened to prevent water under high pressure from escaping through the small hole during operation of the shower head.
